(19) United States
(12) Patent Application Publication
(10) Pub. No.: US 2002/0045531 A1
(43) Pub. Date: Apr. 18, 2002

(54) Oriented sintered ceramic product and manufacturing method thereof

(76) Inventors: Toru Suzuki, Ibaraki (JP); Yoshio Sakka, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 09/854,528

(22) Filed: May 15, 2001

(30) Foreign Application Priority Data
Oct. 18, 2000 (JP) 2000-317323

(51) Int. Cl. C04B 35/10; C04B 35/46; C04B 35/48

(52) U.S. Cl. 501/98.4; 264/434; 264/435; 501/103; 501/1; 501/127; 501/134; 501/123; 501/153

(57) ABSTRACT

A method of manufacturing oriented sintered ceramic product which enables to manufacture an oriented sintered product with an average crystal grain size of 20 μm or less and a grain width 0.4 times or less of the grain size, or an oriented sintered product with an average crystal grain size of 20 μm or more and a grain width 0.5 times or more of the grain size with no grain growth of plate-like seed crystals, the method comprising dispersing a non-ferromagnetic powder having a not-cubic crystal structure into a slurry, consolidating the slurry under a magnetic field and sintering the molding product.

### BACKGROUND OF THE INVENTION

1. Field of the Invention

This invention concerns a method of manufacturing an oriented sintered ceramic product and an oriented sintered ceramic product obtained by the method.

2. Related Art

Sintered ceramic products have generally been used as grinding and cutting materials, high temperature material and various functional materials. For example, sintered alumina series products have features of excellent corrosion resistance, mechanical strength, hardness and wear resistance, and have been put to practical use, for example, in mechanical parts, electric or electronic materials and optical materials.

Such sintered ceramic products have been improved for the characteristics such as toughness and strength and light transmittance by controlling the fine structures of them in recent years. For example, refined oriented sintered products can be mentioned as an example of such fine structure control. A manufacturing method comprising a refining step and an orientation step has been known for manufacture of refined oriented sintered product. In the refining step, a powder can be dispersed finely by using a colloid step as one of manufacturing processes for sintered products and molded to a high density by dispersing the powder into a liquid and consolidated to mold the same by slip casting or the like. In the orientation step where the powder is alumina, for instance, a method of mixing plate-like alumina and granular alumina powder growing grains from the mixture using the plate-like alumina as the seed has been known.

Japanese Patent Laid-Open No. 315915/1995 and Japanese Patent Laid-Open No. 88218/1994 disclose manufacturing methods for oriented sintered alumina product and oriented sintered zinc oxide product by using the method described above. In the oriented sintered alumina product, a powder comprising a relatively large crystal grains with an average crystal grain size of 20 to 200 μm at a surface on which C plane is oriented and having a relatively large ellipticity with an aspect ratio of the grain size of 0.4 times or less.

However, in the existent methods of manufacturing the oriented sintered product described above, the average crystal grain size is from 20 to 200 μm and the aspect ratio is limited to 0.4 or less and it has been difficult to orient a powder having a fine crystal grain size with an average grain size of 20 μm or less or having an aspect ratio of 0.4 or more, that is, having a grain shape closer to a spherical shape.

This is because plate-like seed crystals are grown in the existent manufacturing method for the oriented sintered product and, after all, it is difficult in principle to produce fine powder or more spherical powder.

Recently, industrial demand has been increased for making the size finer, increasing the strength more and improving the function for various kinds of materials. For example, it has been desired for the provision of various kinds of oriented sintered ceramic products having a granular shape of finer size and closer to spherical shape such as oriented alumina with an average crystal grain size of 20 μm or less and an aspect ratio of 0.4 or less, or oriented alumina with an average crystal grain size of 20 μm or more and an aspect ratio of 0.5 times or more. However, methods for satisfying such demand have not yet been known at present.

This invention has been accomplished in view of the foregoing situations and it intends to provide new oriented sintered ceramic products having fine structure and highly controlled orientation, capable of manufacturing an oriented sintered product with an average crystal grain size of 20 μm or less and an aspect ratio of 0.4 or less, or an oriented sintered alumina ceramic product with an average crystal grain size of 20 μm or more and an aspect ratio of 0.5 or more, with no crystal growing of plate-like seed crystals, as well as a manufacturing method therefor.

### SUMMARY OF THE INVENTION

For attaining the foregoing subject, this invention provides, as a first feature, a method of manufacturing an oriented sintered ceramic product, which comprises dispersing a non-ferromagnetic powder having a not-cubic crystal structure into a solvent, solidifying to mold the slurry in a magnetic field and then sintering the same.

As a second feature, this invention provides a method of manufacturing an oriented sintered ceramic product in which the non-ferromagnetic powder is a not-cubic system ceramic powder.

As a third feature, this invention provides a method of manufacturing the oriented sintered ceramic product as described above in which the ceramic powder comprises an alumina powder, titanium dioxide powder, aluminum nitride powder, tetragonal zirconia powder, zinc oxide powder, tin oxide powder or hydroxyapatite powder, or a composite mixture containing them.

As a fourth feature, this invention provides an oriented sintered ceramic product obtained by the manufacturing method described above.

As a fifth feature, this invention provides an oriented sintered alumina product in which (006) diffraction intensity is 1.2 times or more as (110) diffraction intensity in accordance with X-ray diffractiometry at the surface on which the C plane of alumina crystal is oriented, the average crystal grain size is 20 μm or less at the surface parallel with the surface on which the C plane is oriented, or the average crystal grain size is 20 μm or more, the aspect ratio of the crystal grain size is 0.4 or greater and 1 or less at a surface perpendicular to the surface on which the C plane is oriented.

As a sixth feature, this invention provides a crystal oriented sintered titanium dioxide ceramic product.

As a seventh feature, this invention provides an oriented sintered titanium dioxide ceramic product, which is a crystal oriented sintered rutile structure titanium dioxide product and in which (002) diffraction intensity is greater than (110) diffraction intensity in accordance with X-ray diffractiometry.

Further, as an eighth feature, this invention provides an oriented sintered tetragonal zirconia ceramic product which is a crystal oriented tetragonal zirconia sintered product.

As a ninth feature, this invention provides a crystal oriented sintered tetragonal zirconia ceramic product in which (002) diffraction intensity is greater than (200) diffraction intensity in accordance with X-ray diffractiometry.

That is, this invention has a prominent feature of enabling to provide an oriented sintered ceramic product of a new structure not known so far, by breaking through conventional knowledges or customs of neglecting magnetic anisotropy of non-ferromagnetic material such as alumina, and by dispersing a non-ferromagnetic powder having not-cubic crystal structure such as an alumina powder into slurry and molding the slurry in a magnetic field, while taking the magnetic anisotropy into consideration even for the non-ferromagnetic material.

This is based on the novel finding as a result of an earnest study of the inventor that those substances having crystal structures other than the cubic system often exhibit crystal magnetic anisotropy between the direction of C axis and the direction perpendicular to the C axis (C plane), so that magnetic anisotropy is innegligible also for alumina having a hexagonal system crystal structure.

This is based on the background along with the development of super-conductive magnets in recent years that strong magnetic fields can be obtained relatively easily without using liquid helium and magnetic fields can be exerted as a not negligible energy from outside field even for the non-ferromagnetic substances.

### BRIEF DESCRIPTION OF THE DRAWINGS

FIG. 1 is a view illustrating a direction of applying a magnetic field in Example 1;

FIG. 2 is a chart illustrating the result of measurement of X-ray diffractiometry in a sintered product obtained in Example 1;

FIG. 3 is a photograph of the texture of the sintered product obtained in Example 1 for a surface parallel with the direction of applying the magnetic field;

FIG. 4 is a view illustrating the direction of applying a magnetic field in Example 2:

FIG. 5 is a chart illustrating the result of measurement of X-ray diffractiometry in a sintered product obtained in Example 2;

FIG. 6 is a chart illustrating the result of measurement of X-ray diffractiometry in a sintered product obtained in Example 3;

FIG. 7 is a chart illustrating the result of measurement of X-ray diffractiometry in a sintered product obtained in Example 4;

FIG. 8 is a photograph for the texture of the sintered product obtained in Example 4 for a surface parallel with the direction of applying the magnetic field;

FIG. 9 is a photograph for the texture of the sintered product obtained in Example 5 for a surface parallel with the direction of applying the magnetic field;

FIG. 10 is a chart illustrating the result of measurement of X-ray diffractiometry in a sintered product obtained in Example 6;

FIG. 11 is a chart illustrating the result of measurement of X-ray diffractiometry in a sintered product obtained in Example 7;

FIG. 12 is a chart illustrating the result of measurement of X-ray diffractiometry in a sintered product obtained in Example 8;

FIG. 13 is a chart illustrating the result of measurement of X-ray diffractiometry in a sintered product obtained in Example 9;

FIG. 14 is a chart illustrating the result of measurement of X-ray diffractiometry in a sintered product obtained in Example 10;

FIG. 15 is a chart illustrating the result of measurement of X-ray diffractiometry in a sintered product obtained in Example 11;

FIG. 16 is a chart illustrating the result of measurement of X-ray diffractiometry in a sintered product obtained in Example 12;

FIG. 17 is a chart illustrating the result of measurement of X-ray diffractiometry in a sintered product obtained in Example 13;

FIG. 18 is a chart illustrating the result of measurement of X-ray diffractiometry in a sintered product obtained by the existent method;

FIG. 19 is a photograph of the texture of a sintered product obtained by the existent method.

### DESCRIPTION OF THE PREFERRED EMBODIMENTS

This invention has the features as described above and preferred embodiments thereof are to be explained below.

The manufacturing method of this invention as described above utilizes the crystal magnetic anisotropy and the strong magnetic field and it is possible to control the orientation of any powder having crystal magnetic anisotropy in accordance with this method.

For instance, by orienting alumina, strength and toughness can be improved together, increase of the linear transmissivity can be expected in light permeable alumina and it is possible to obtain alumina at high purity and with extremely higher degree of orientation. Such alumina can also be expected as the starting material for manufacturing single crystals. Further, since it is not necessary to use plate-like alumina as seeds for grain growth in the method of this invention, oriented alumina can be manufactured from only one kind of alumina powder to also save the manufacturing cost.

The powder as an object of this invention is a non-ferromagnetic powder having a non-cubic system crystal structure and can include various kinds of materials. Ceramics can be mentioned as typical examples which include alumina, titania, zinc oxide, aluminum nitride, tetragonal zirconia, tin oxide and hydroxyapatite. The powder is at first dispersed in a solvent to prepare a slurry. In this case, a dispersing aid, for example, an electrolyte is used optionally.

As a solvent, water, an organic solvent such as an non-aqueous alcohol such as ethanol or ether, or an appropriate mixture of such solvents may be used.

The concentration of the powder and the concentration of the electrolyte in the slurry can be determined depending on the kind of the powder and the solvent, the grain size of the powder, and so on.

The slurry in which the powder is dispersed is then served for molding under a magnetic field. A method of colloid process, for example, slip casting is suitably adopted for consolidation. The colloid process can include slip casting, as well as gel casting, pressure filtration, tape casting and electrophoretic deposition.

The magnetic field to be applied is generally 1 T or more and, preferably, 7 T or more. If the magnetic field is less than 1 T or less than 7 T, effects of the magnetic field on the ceramic particles is weak to cause less orientation.

In the case of using the magnetic field, the orienting direction can be selected optionally by applying the magnetic field from the optional direction.

The thus obtained consolidated product is then sintered. The sintering method and the conditions therefor can include, for example, sintering at 1300° C. to 1800° C. for 1 to 3 hours in atmospheric air in a case of alumina, and sintering at 1800° C. to 2000° C. for 1 to 3 hours in a nitrogen atmosphere in a case of aluminum nitride. It will be possible to select various other sintering methods and sintering conditions for obtaining desired values for the average grain size or the aspect ratio.

In this invention, for instance, in a case of an alumina powder, the toughness can be improved a fine structure in which (006) diffraction intensity is 1.2 times or more as (110) diffraction intensity in accordance with X-ray diffractiometry at a surface on which the C plane is oriented and an average grain size is 10 μm or less.

Further, abnormal grain growth of alumina in random directions at high temperature can be suppressed to obtain stable characteristics at high temperature.

Further, alumina in which (006) diffraction intensity is 1.2 times or more as (110) diffraction intensity in accordance with X-ray diffractiometry at a surface on which the C plane is oriented and an average grain size is 20 μm or more can be decreased for the direction dependence of strength and toughness by increasing the aspect ratio to 0.5 or more.

In other words, unless not plate-like but only the granular alumina powder was used for the starting material, oriented alumina having a fine texture with an average grain size of 20 μm or less or having an aspect ratio of 0.5 or more can not be prepared and, unless the magnetic field is exerted in the slurry during molding and then the molding product is further heated, the powder can not be oriented in this invention.

Referring to the aspect ratio for defining the orientation of the alumina texture in this invention, the aspect ratio (A) is expressed as:

A=dv/dh

where dv represents the grain width in the direction perpendicular to the C plane and dh represents the grain size in the direction parallel with the C plane of the alumina crystal.

Then, as described above, according to this invention, oriented sintered titanium dioxide ceramic product and oriented sintered tetragonal zirconia ceramic product not known so far can also be provided.

This invention is to be described more in details referring to examples.

### EXAMPLES

Oriented sintered products were manufactured as examples of this invention. Further, for comparison, sintered product by the existent method was also manufactured.

### Example 1

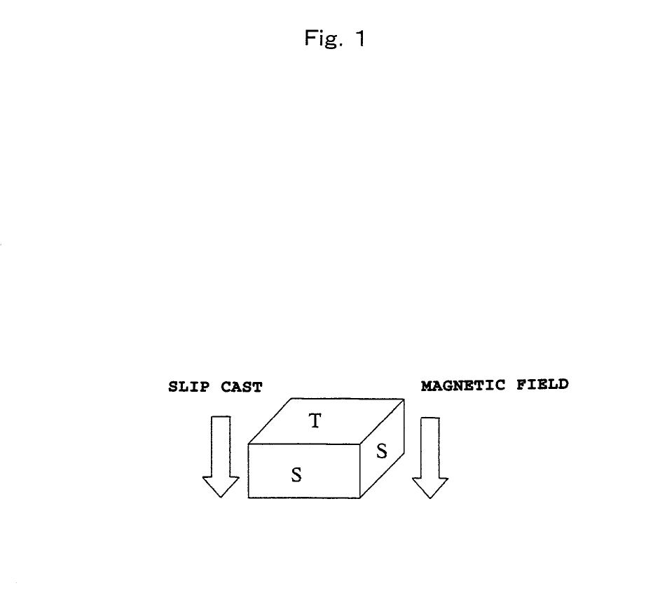

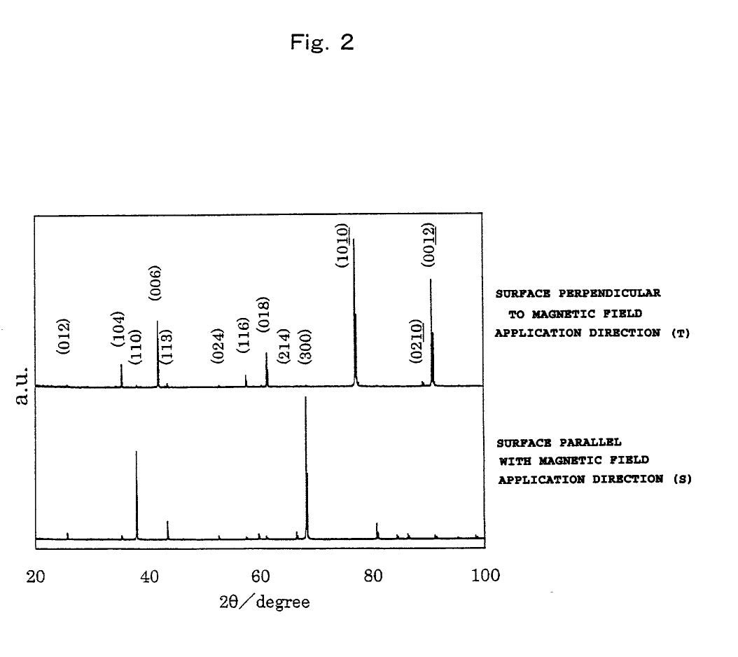

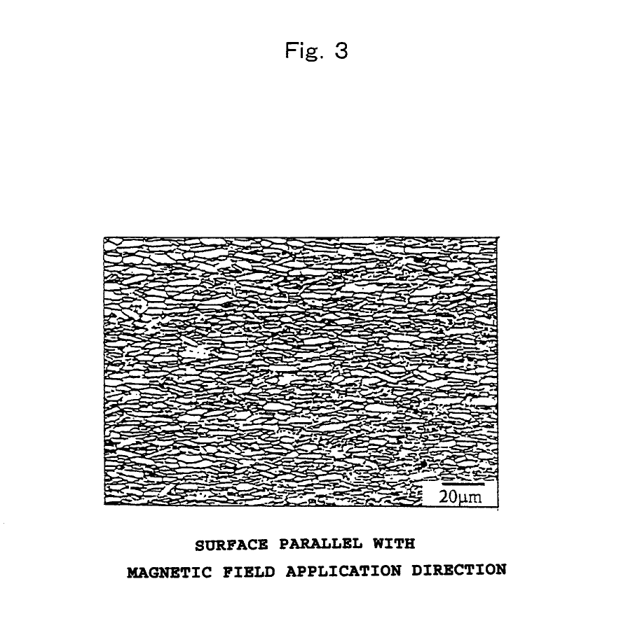

A slurry was prepared by weighing an alumina powder of an average particle size of 0.1 μm so as to be 40 vol % as a solid phase concentration and dispersing the same into an aqueous solution to which an appropriate amount of a polymeric electrolyte (ammonium polycarboxylate) was added. For re-dispersing weakly coagulated powder, they were ultrasonically stirred while being dispersed by a stirrer. The slurry was cast into a porous mold and the powder was consolidated to high density by absorbing the solution (slip casting) under a magnetic field. The intensity of the magnetic field was 10 T and, as shown in FIG. 1, the direction of applying the magnetic field was in parallel with the slip casting direction. The consolidated product was heated at 1600° C. for 2 hours in atmospheric air to obtain a oriented sintered product. FIG. 2 shows the result of measurement of X-ray diffractiometry for the sintered product. FIG. 3 is a photograph for of texture of the sintered product for a surface in parallel with the direction of applying the magnetic field. It was confirmed that the oriented sintered product was obtained even when the average crystal grain size is 20 μm or less.

It was confirmed that the resultant oriented sintered alumina ceramic product had (006) diffraction intensity 23.9 times as (110) diffraction intensity in according with X-ray diffractiometry at the surface on which the C plane was oriented and, the average crystal grain size was about 10 μm and the aspect ratio was about 0.28.

### Example 2

In the same manner as in Example 1, a slurry was prepared by weighing an alumina powder of an average particle size of 0.1 μm so as to be 40 vol % by solid phase concentration and dispersing the same in an aqueous solution by adding an appropriate amount of a polymeric electrolyte (ammonium polycarboxylate).

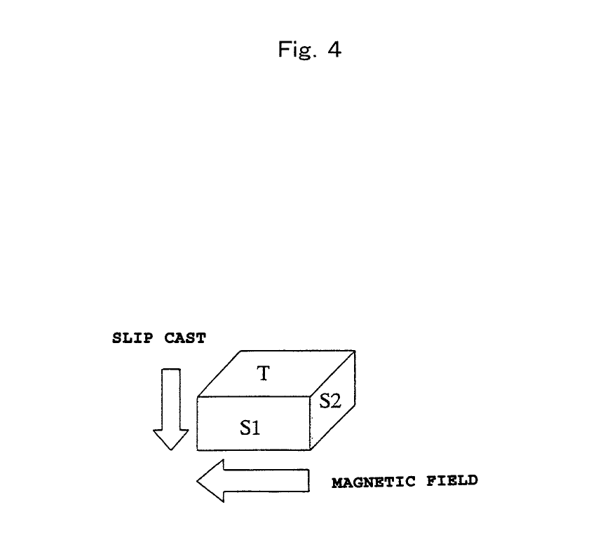

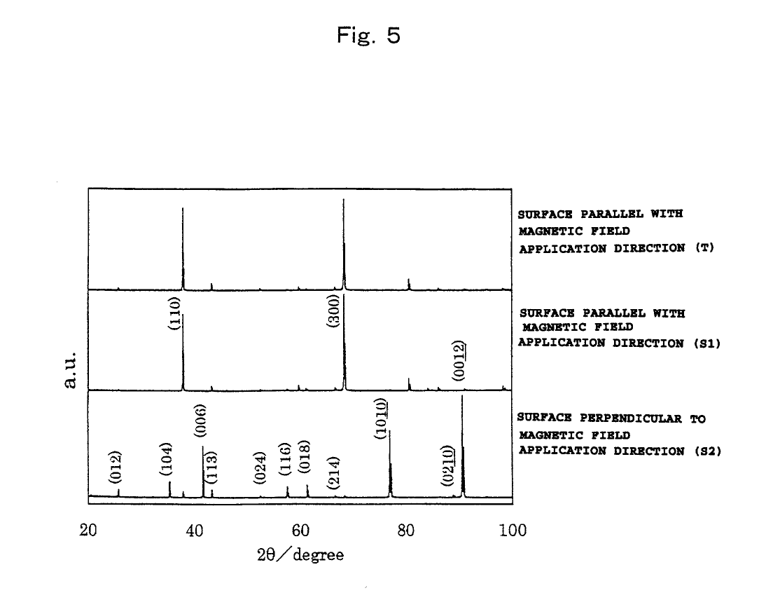

The intensity of the magnetic field applied upon slip casting was 10 T and the direction of applying the magnetic field was perpendicular to the slip casting direction as shown in FIG. 4. The molding product was heated at 1600° C. for 2 hours in atmospheric air to obtain a sintered product. The result for the measurement of X-ray diffractiometry for the sintered product was shown in FIG. 5. It was confirmed that oriented sintered product was obtained even when the average crystal grain size was 20 μm or less in this invention. The intensity ratio of the X-ray diffraction also measured in Example 2 was 7.5.

### Example 3

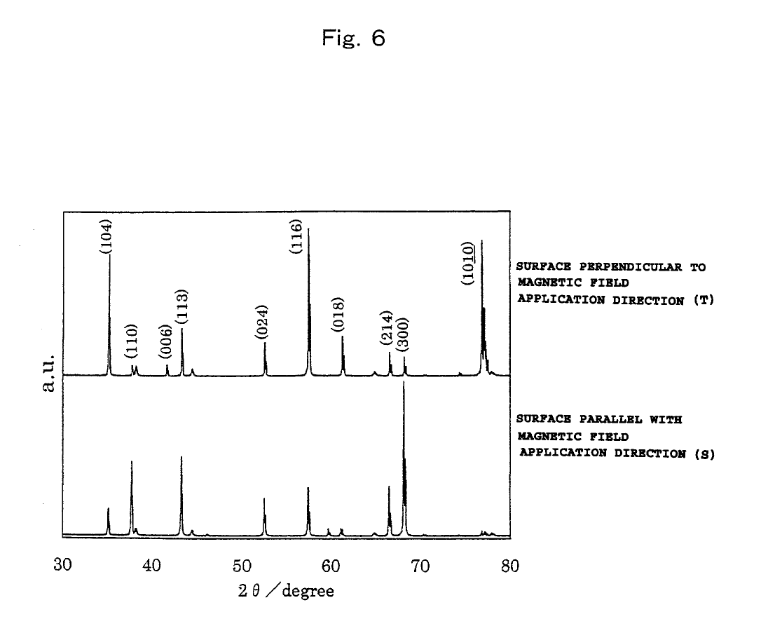

In the same manner as in Example 1, a slurry was prepared by dispersing an alumina powder into an aqueous solution to which an appropriate amount of a polymeric electrolyte (ammonium polycarboxylate) was added. The alumina powder had an average particle size of 0.4 μm and weighed such that the solid phase concentration was 40 vol %. A sintered product was obtained in the same dispersion method for the alumina powder in the slurry, magnetic field application conditions during slip casting and heating conditions for the molding product as those of Example 1. FIG. 6 shows the result for the measurement of X-ray diffractiometry of the sintered product. It was confirmed that oriented sintered product was obtained even when the average crystal grain size was 20 μm or less in this invention. The intensity ratio of the X-ray diffraction also measured in Example 3 was 1.2.

### Example 4

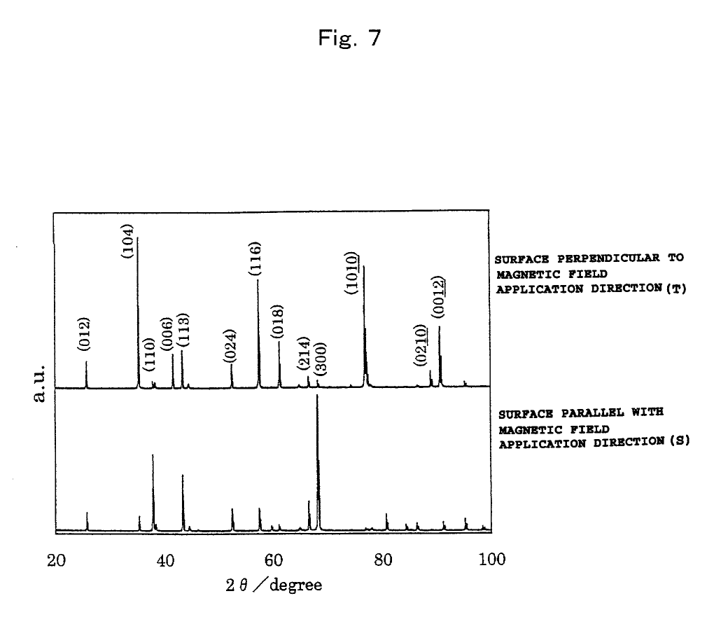

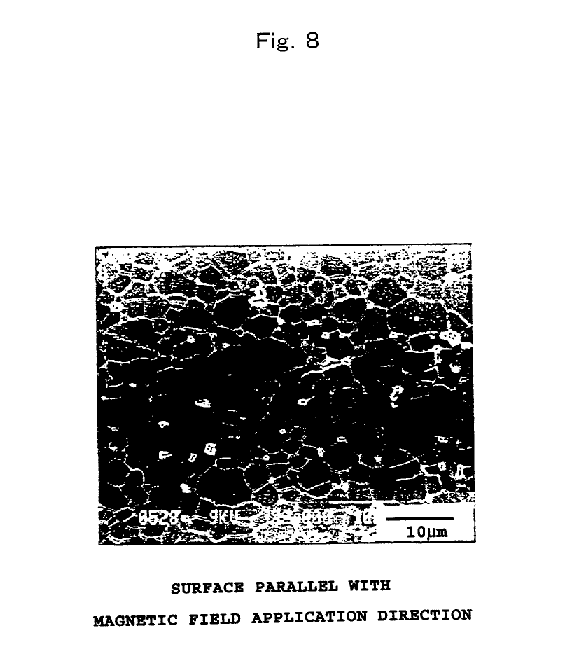

In the same manner as in Example 1, a slurry was prepared by dispersing an alumina powder into an aqueous solution to which an appropriate amount of a polymeric electrolyte (ammonium polycarboxylate) was added. The alumina powder was of an average particle size of 0.1 μm and weighed such that the solid phase concentration was 40 vol %. For re-dispersing weakly coagulated powder, they were ultrasonically stirred while being dispersed by a stirrer. The slurry was cast into a porous mold and the powder was consolidated to high density by absorbing the solution (slip casting) under a magnetic field. The intensity of the magnetic field was 10 T and the direction of applying the magnetic field was in parallel with the slip casting direction. The molding product was heated at 1400° C. for 2 hours in atmospheric air to obtain a oriented sintered product. FIG. 7 shows result of measurement of X-ray diffractiometry for the sintered product. FIG. 8 is a photograph for the texture of the sintered product for the surface in parallel with the direction of applying the magnetic field. It was confirmed that the oriented sintered product was obtained even when the average crystal grain size was 20 μm or less according to this invention.

Also in Example 4, the measured intensity ratio of the X-ray diffraction was 4.7, the crystal grain size was about 5 μm and the aspect ratio was about 0.6.

### Example 5

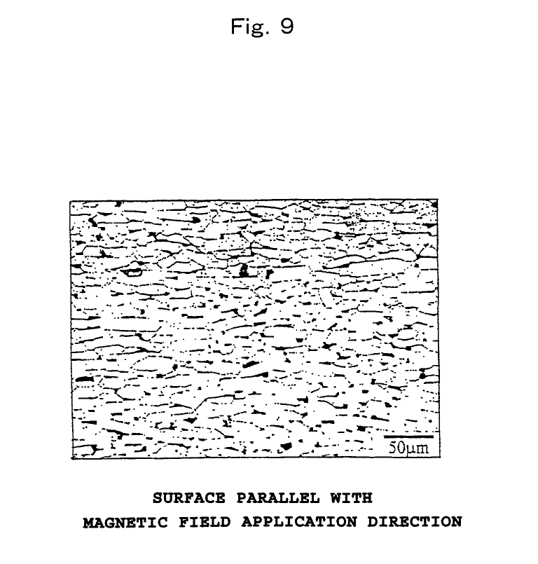

In the same manner as in Example 1, a slurry was prepared by weighing an alumina powder of an average particle size of 0.1 μm so as to be 40 vol % by solid phase concentration and dispersing the same in an aqueous solution to which an appropriate amount of a polymeric electrolyte (ammonium polycarboxylate) was added. The intensity of the magnetic field applied upon slip casting was 10 T and the direction of applying the magnetic field was parallel with the slip casting direction. The molding product was heated at 1600° C. for 12 hours in atmospheric air to obtain a sintered product. FIG. 9 is a photograph for the texture of the sintered product for the surface in parallel with the direction of applying the magnetic field. In this invention, it was confirmed that the oriented sintered product was obtained even when the average grain size was 20 μm or more and the aspect ratio was 0.4 or more.

### Example 6

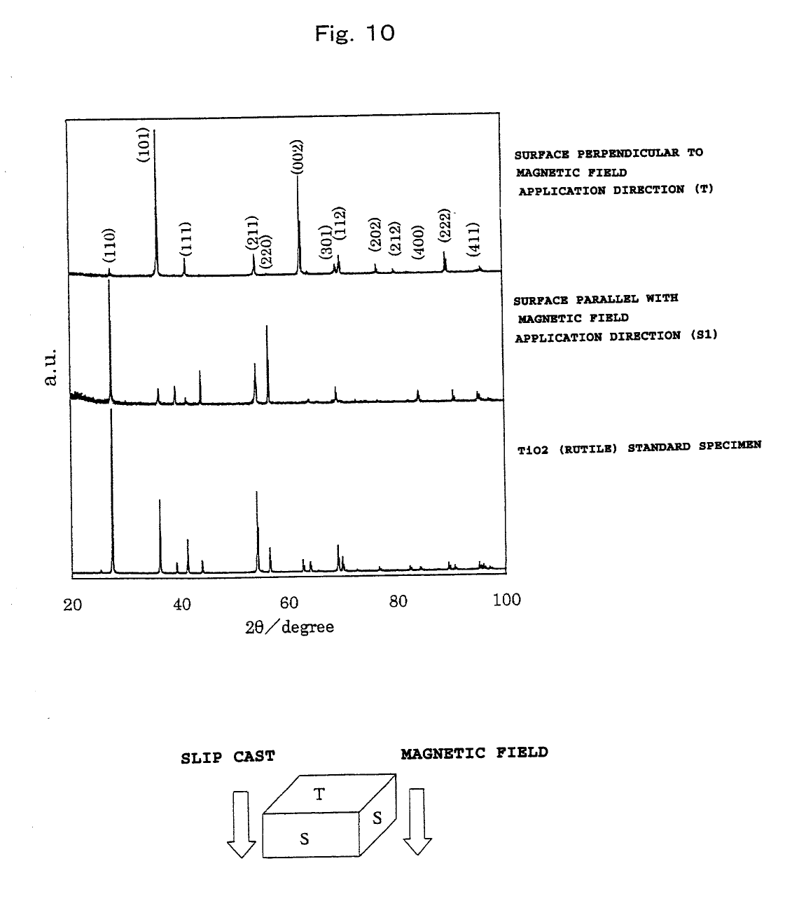

A slurry was prepared by weighing a titanium dioxide powder (anatase: 80%) of an average particle size of 30 nm so as to be 20 vol % as a solid phase concentration and dispersing the same into an aqueous solution to which an appropriate amount of a polymeric electrolyte (ammonium polycarboxylate) was added. For re-dispersing the weakly coagulated powder, it was ultrasonically stirred while being dispersed by a stirrer. The slurry was cast into a porous mold and the powder was consolidated to high density by absorbing the solution (slip casting) under a magnetic field. The intensity of the magnetic field was 10 T and the direction of applying the magnetic field was in parallel with the slip casting direction. The consolidated product was heated at 1300° C. for 2 hours in atmospheric air to obtain a oriented sintered product. FIG. 10 shows the result of measurement of X-ray diffractiometry for oriented titanium dioxide.

It can be seen from FIG. 10 that the titanium dioxide sintered product had a crystal oriented rutile structure having (002) diffraction intensity greater than (110) diffraction intensity by X-ray diffractiometry.

### Example 7

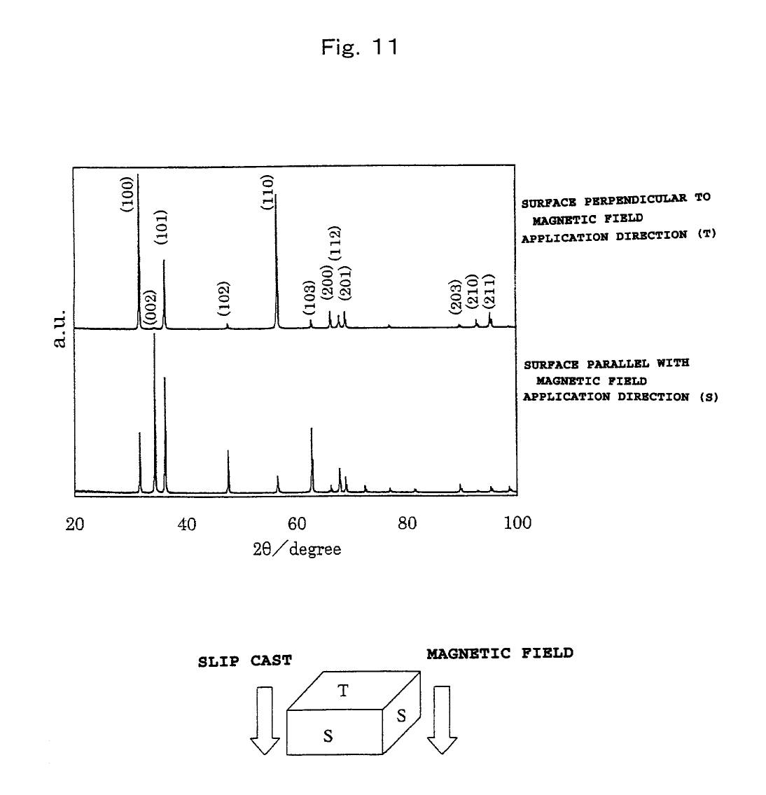

A slurry was prepared by weighing a zinc oxide powder of an average particle size of 40 nm so as to be 20 vol % as a solid phase concentration and dispersing the same into an aqueous solution to which an appropriate amount of a polymeric electrolyte (ammonium polycarboxylate) was added. For re-dispersing weakly coagulated powder, it was ultrasonically stirred while being dispersed by a stirrer. The slurry was cast into a porous mold and the powder was consolidated to high density by absorbing the solution (slip casting) under a magnetic field. The intensity of the magnetic field was 10 T and the direction of applying the magnetic field was in parallel with the slip casting direction. The consolidated product was heated at 1400° C. for 5 hours in atmospheric air to obtain a oriented sintered product. FIG. 11 shows the result of measurement of X-ray diffractiometry for the oriented zinc oxide.

### Example 8

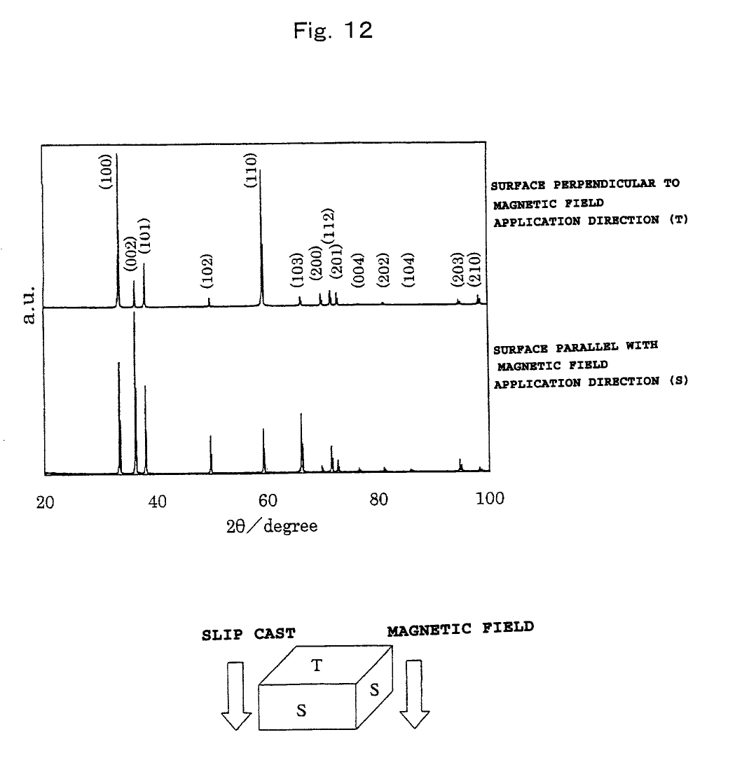

A slurry was prepared by weighing an aluminum nitride powder of an average particle size of 0.69 μm so as to be 50 vol % as a solid phase concentration and dispersing the same into an ethanol solution to which an appropriate amount of an ester series polymeric electrolyte was added. For re-dispersing weakly coagulated particle, it was ultrasonically stirred while being dispersed by a stirrer. The slurry was cast into a porous mold and the powder was consolidated to high density by absorbing the solution (slip casting) under a magnetic field. The intensity of the magnetic field was 10 T and the direction of applying the magnetic field was in parallel with the slip casting direction. The consolidated product was heated at 1900° C. for 2 hours in an nitrogen atmosphere to obtain a oriented sintered product. FIG. 12 shows the result of measurement of X-ray diffractiometry for the oriented aluminum nitride.

### Example 9

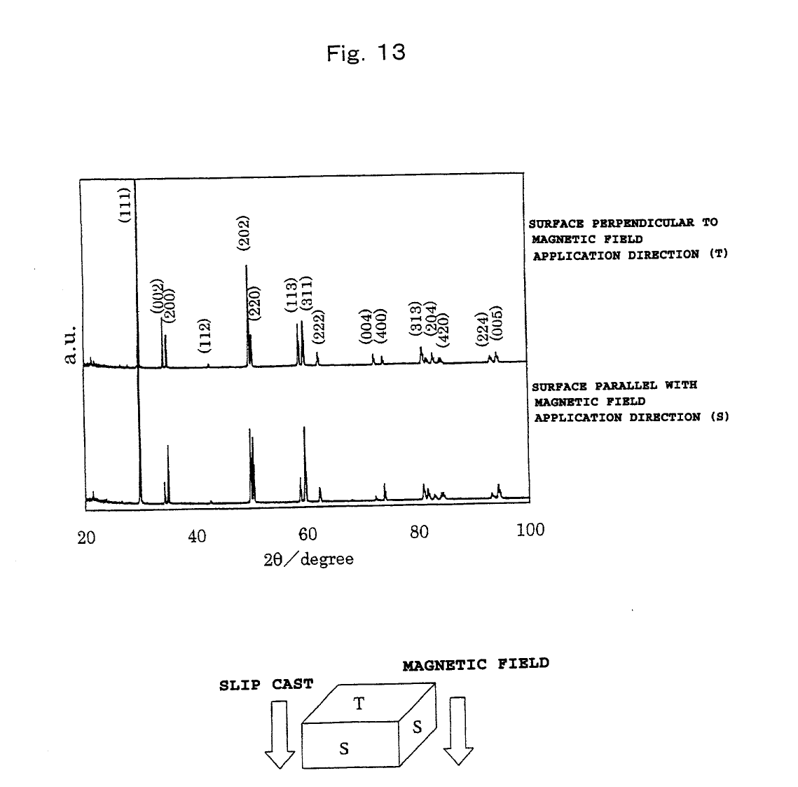

A slurry was prepared by weighing 12 mol % CeO₂ stabilized tetragonal system zirconia powder of an average particle size of 94 nm so as to be 30 vol % as a solid phase concentration and dispersing the same into an aqueous solution to which an appropriate amount of a polymeric electrolyte (ammonium polycarboxylate) was added. For re-dispersing weakly coagulated particle, it was ultrasonically stirred while being dispersed by a stirrer. The slurry was cast into a porous mold and the powder was consolidated to high density by absorbing the solution (slip casting) under a magnetic field. The intensity of the magnetic field was 10 T and the direction of applying the magnetic field was in parallel with the slip casting direction. The consolidated product was heated at 1600° C. for 2 hours in an atmospheric air to obtain a oriented sintered product. FIG. 13 shows the result of measurement of X-ray diffractiometry for the oriented tetragonal system zirconia.

### Example 10

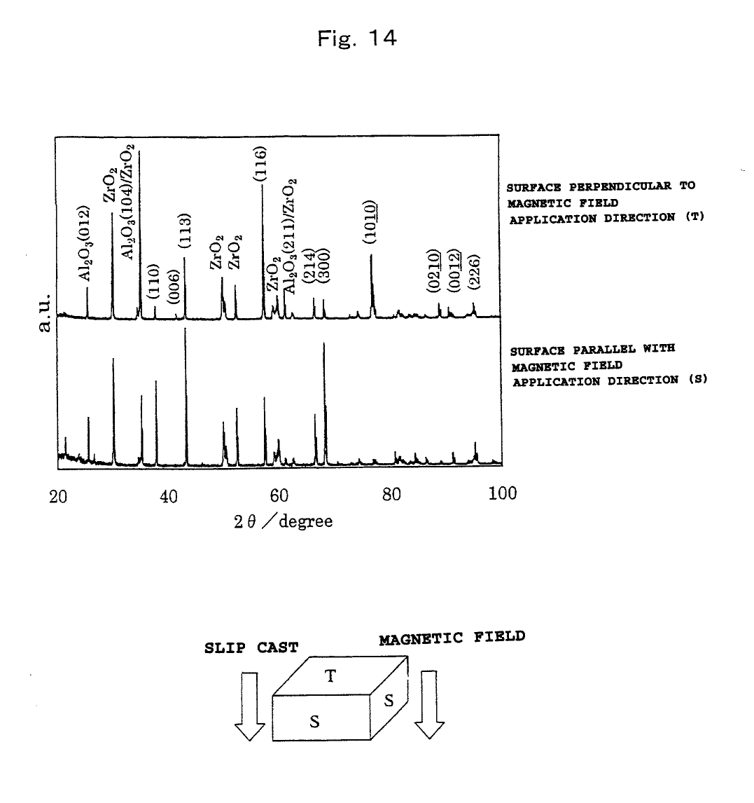

A slurry was prepared by mixing 10 vol % of 3 mol % Y₂O₃ stabilized tetragonal system zirconia powder of 60 nm average particle size to an aluminum powder of 0.1 μm average particle size, which was weighed so as to be 30 vol % by solid phase concentration and dispersing the same in an aqueous solution to which an appropriate amount of a polymeric electrolyte (ammonium polycaboxylate) was added. For re-dispersing weakly coagulated particle, it was ultrasonically stirred while being dispersed by a stirrer. The slurry was cast into a porous mold and the powder was consolidated to high density by absorbing the solution (slip casting) under a magnetic field. The intensity of the magnetic field was 10 T and the direction of applying the magnetic field was in parallel with the slip casting direction. The consolidated product was heated at 1600° C. for 2 hours in atmospheric air to obtain a oriented sintered product. FIG. 14 shows the result of measurement of X-ray diffractiometry for oriented 10 vol % tetragonal system zirconia (stabilized with 3 mol % Y₂O₃) dispersed alumina.

### Example 11

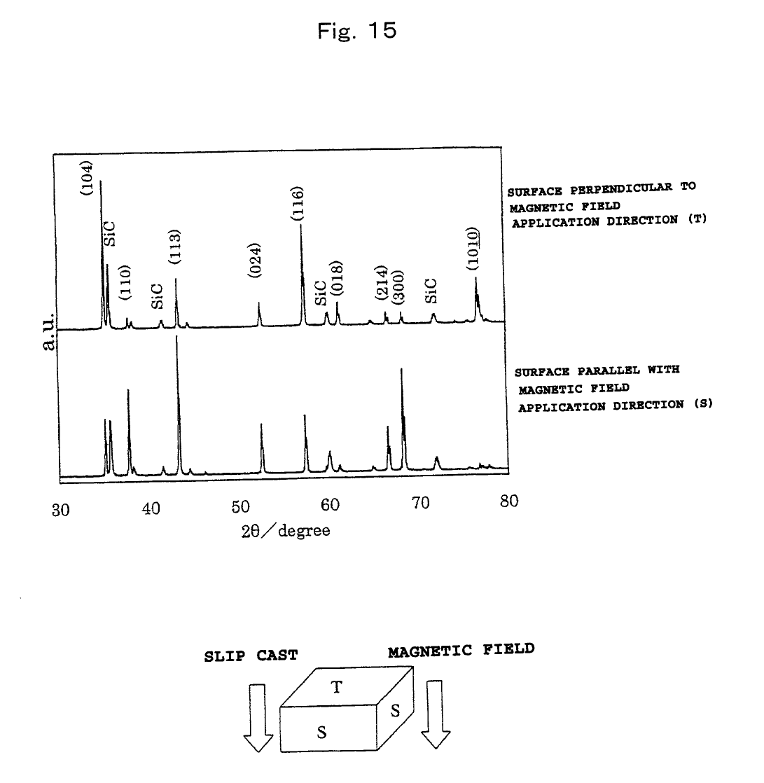

A slurry was prepared by mixing 20 vol % of silicon carbide whiskers of 0.5 μm diameter and 30 μm length to an aluminum powder of 0.1 μm average particle size, weighing them so as to be 30 vol % by solid concentration and dispersing the same in an aqueous solution to which an appropriate amount of a polymeric electrolyte (ammonium polycaboxylate) was added. For re-dispersing weakly coagulated particle, they were ultrasonically stirred while being dispersed by a stirrer. The slurry was cast into a porous mold and the powder was consolidated to high density by absorbing the solution (slip casting) under a magnetic field. The intensity of the magnetic field was 10 T and the direction of applying the magnetic field was in parallel with the slip casting direction. The consolidated product was heated at 1800° C. for 2 hours in an argon atmosphere to obtain a oriented sintered product. FIG. 15 shows the result of measurement of X-ray diffractiometry for the oriented 20 vol % silicon carbide dispersed alumina.

### Example 12

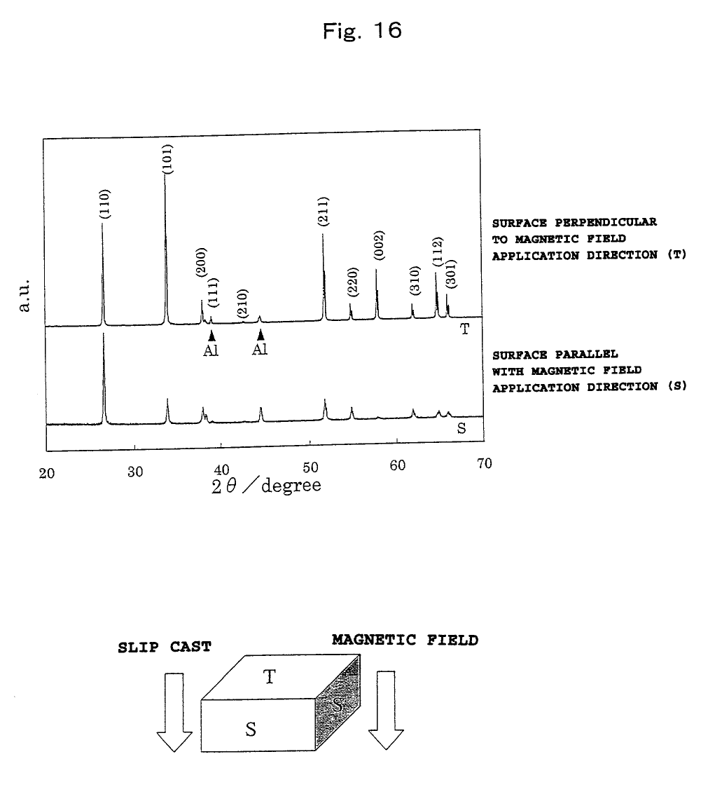

A slurry was prepared by weighing tin oxide powder of an average particle size of 30 nm so as to be 20 vol % as a solid phase concentaration and dispersing the same into an aqueous solution to which an appropriate amount of a polymetric electrolyte (ammonium polycaboxylate) was added. For enhancing the sinterability, 0.5 mol % manganese oxide powder of an average particle size of 30 nm was added, and for re-dispersing weakly coagulated particle, it was ultrasonically stirred while being dispersed by a stirrer. The slurry was cast into a porous mold and the powder was consolidated to high density by absorbing the solution (slip casting) under a magnetic field. The intensity of magnetic field was 10 T and the direction of applying the magnetic field was in parallel with the slip casting direction. The consolidated product was heated at 1200° C. for 2 hours in an atmospheric air to obtain a oriented sintered product. FIG. 16 shows the result of measurement of X-ray diffractiometry for the oriented tin oxide.

### Example 13

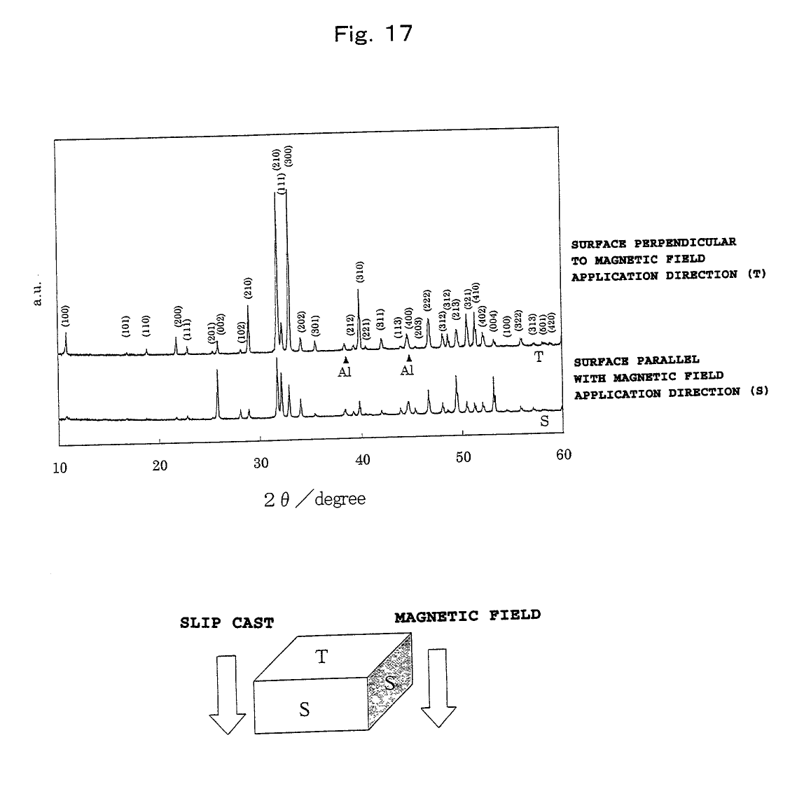

A slurry was prepared by weighing hydroxyapatite powder of an average particle size of 100 nm so as to be 30 vol % as a solid phase concentaration and dispersing the same into an aqueous solution to which an appropriate amount of a polymetric electrolyte (ammonium polycaboxylate) was added. For re-dispersing weakly coagulated particle, it was ultrasonically stirred while being dispersed by a stirrer. The slurry was cast into a porous mold and the powder was consolidated to high density by absorbing the solution (slip casting) under a magnetic field. The intensity of magnetic field was 10 T and the direction of applying the magnetic field was in parallel with the slip casting direction. The consolidated product was heated at 1200° C. for 5 hours in an atmospheric air to obtain a oriented sintered product. FIG. 17 shows the result of measurement of X-ray diffractiometry for the oriented hydroxyapatite.

### Comparative Example

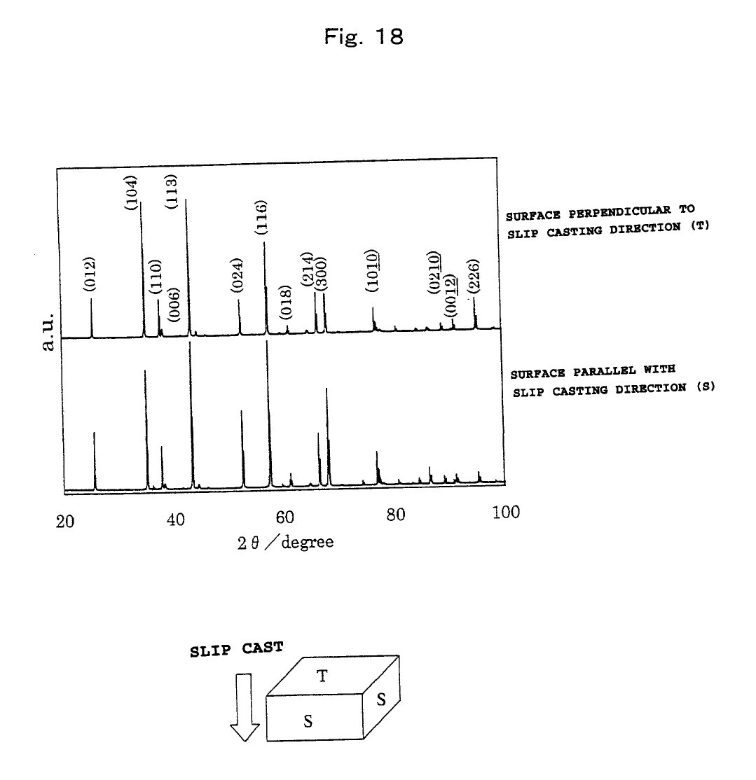

In the same manner as in Example 1, a slurry was prepared by weighing an alumina powder of an average particle size of 0.1 μm so as to be 40 vol % by solid phase concentration and dispersing same into an aqueous solution to which an appropriate amount of a polymeric electrolyte (ammonium polycarboxylate) was added. Then, slip casting was conducted without applying magnetic field as the existent method and then the consolidated product was heated at 1600° C. for 2 hours in an atmospheric air to obtain an alumina sintered product. FIG. 18 shows the result of measurement of X-ray diffractiometry for the sintered product.

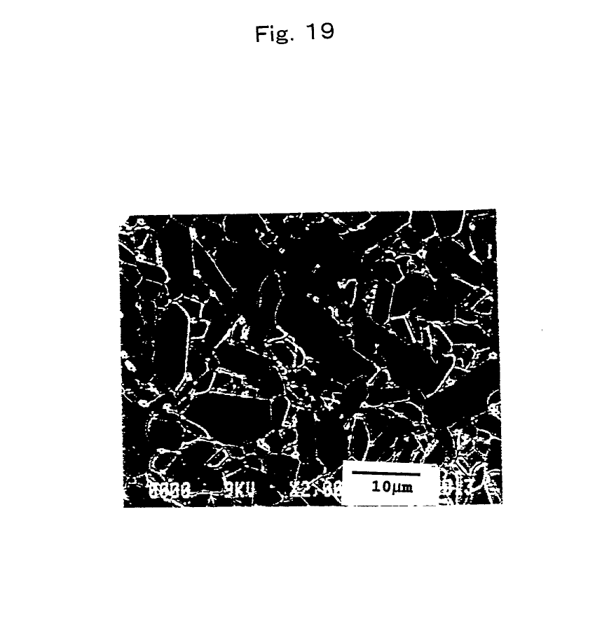

FIG. 19 is a photograph for the texture of the sintered product. it was confirmed that the oriented sintered product could not be obtained by the existent method when the average crystal grain size was 20 μm or less.

As has been described above specifically, it is possible in accordance with this invention to manufacture oriented sintered alumina ceramic product with an average crystal grain size of 20 μm or less and with a grain width 0.4 times or less as the grain size, or oriented sintered alumina ceramic product having an average crystal grain size of 20 μm or more with a grain width 0.5 times or more as the grain diameter, with no grain growth of plate-like seed crystals, and the toughness and the strength of the sintered product can be improved, as well as linear transmissivity can be improved by orienting the light transmittance. Further, this can also provide oriented sintered titatnium dioxide product or oriented sintered tetragonal system zirconia product.

Sintered ceramic product highly controlled for the orientation can be provided in accordance with this invention as described above.

What is claimed is:

1. A method of manufacturing an oriented sintered ceramic product, which comprises dispersing a non-ferromagnetic powder having a not-cubic system crystal structure into a solvent, solidifying to mold the slurry in a magnetic field and then sintering the same.

2. A method of manufacturing an oriented sintered ceramic product as defined in claim 1, wherein the non-ferromagnetic powder is a non-cubic system ceramic powder.

3. A method of manufacturing an oriented sintered ceramic product as defined in claim 2, wherein the ceramic powder comprises an alumina powder, titanium dioxide powder, aluminum nitride powder, tetragonal zirconia powder, zinc oxide powder, tin oxide powder or hydroxyapatite powder, or a composite mixture containing them.

4. An oriented sintered ceramic product obtained by the manufacturing method as defined in any one of claims 1 to 3.

5. An oriented sintered alumina ceramic product in which (006) diffraction intensity is 1.2 times or more as (110) diffraction intensity in accordance with x-ray diffractiometry at a surface on which the C plane of alumina crystal is oriented, the average crystal grain size is 20 μm or less at the surface parallel with the surface on which the C plane is oriented, or the average crystal grain size is 20 μm or more and an aspect ratio of the crystal grain size is 0.4 or greater and 1 or less at a surface vertical perpendicular to the surface on which the C plane is oriented.

6. An oriented sintered titanium dioxide ceramic product which is a crystal oriented sintered titanium dioxide product.

7. An oriented sintered titanium dioxide ceramic product as defined in claim 6, which is a crystal oriented sintered rutile structure titanium dioxide product in which (002) diffraction intensity is greater than (110) diffraction intensity in accordance with X-ray diffractiometry.

8. An oriented sintered tetragonal zirconia ceramic product which is a crystal oriented sintered tetragonal zirconia product.

9. A crystal oriented sintered tetragonal zirconia ceramic product as defined in claim 8 wherein (002) diffraction intensity is greater than (200) diffraction intensity in accordance with X-ray diffractiometry.
